(19) United States
(12) Patent Application Publication
(10) Pub. No.: US 2008/0095518 A1
(43) Pub. Date: Apr. 24, 2008

(54) Method of transmitting data having insertion of audio information

(76) Inventors: Ming-Jane Hsieh, Taipei City (TW); Ching-Chi Lei, Taipei County (TW); Jin-Sheng Gong, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/874,212

(22) Filed: Oct. 18, 2007

(30) Foreign Application Priority Data
Oct. 18, 2006 (TW) 095138369

(51) Int. Cl. H04N 5/91

(52) U.S. Cl. 386/96

(57) ABSTRACT

A method of transmitting data by inserting audio information for use within a video editing apparatus includes encoding at least one analog audio signal into digital audio channel information according to an encoding format, the digital audio channel information including a length element and an audio encoded element; utilizing at least a first noise bit to replace at least one bit from within the length element to thereby generate a replacement length element; utilizing at least a second noise bit to replace at least one bit from the audio encoded element to thereby generate a replacement audio encoded element; generating replacement audio channel information according to the replacement length element and the corresponding replacement audio encoded element; according to all the replacement audio channel information generating a replacement digital audio sample; and inserting the replacement digital audio sample into a blanking section of transmitted data.

### BACKGROUND OF THE INVENTION

1. Field of the Invention

The present invention relates to a method of transmitting data, and more particularly, to a method of inserting replacement digital audio information into transmitted data.

2. Description of the Prior Art

According to the formats traditionally employed by television broadcasting systems, North America and Japan utilize NTSC; and England, Germany, and China utilize PAL. Additionally, France, Eastern Europe, and Russia utilize SECAM. The formats for these television-broadcasting systems have differences related to their scanning line numbers, and produce different screen resolutions. Concerning the above described systems, the Consultative Committee of International Radio (CCIR) has defined several internationally used standards for digital television transmission.

Taking the 8-bit encoding format defined in CCIR standard CCIR656 as an example, please refer to FIG. 1 and FIG. 2 showing an analog television signal scan line sampled with a chrominance to luminance ratio of 4:2:2, which is then transformed into digital image information having a hexadecimal value to perform encoding. The digital image information is written into a digital scanning line 1 according to an 8-bit or a 10-bit digital encoding format. The digital scanning line 1 is generated according to an 8-bit digital encoding format and includes an end of active video (EAV) section 10, a start of active video (SAV) section 12, a blanking section 14, and an active video section 16. The active video section 16 is written into the digital image information, the start of active video section 12 is positioned before the active video section 16, the end of active video section 10 is positioned after the active video section 16, and the blanking section 14 is positioned from the end of active video section 10 to the start of active video section 12.

Continuing, please again refer to FIG. 2 showing the end of active video section 10 and the start of active video section 12 each having a reference element 100, 120 and each having an information element 102, 122. Each reference element 100, 120 is fixed at a hexadecimal value having three words being set to [FF 00 00], wherein one word is formed by eight bits. When a digital television decodes digital scanning line 1 and reads three words of data being set to [FF 00 00], this indicates that the digital television has already read to the start of active video section 12 or to the end of active video section 10 in the digital scanning line 1. The information elements 102, 122 are utilized to indicate a first field or a second field of a frame, a field or line blanking section, a start of active video section 12, or an end of active video section 10. Determination of the field or line blanking indication, the start of active video section 12 indication or the end of active video section 10 indication is performed utilizing the [XY] value shown in FIG. 2. The value [XY] indicates a changing hexadecimal value. In this way, the end of active video section 10 and the start of active video section 12 each include the four words [FF 00 00 XY].

Additionally, the digital image information of the active video section 16 is ordered Cb0, Y0, Cy0, Y1, Cb2, Y2 . . . Cy718, Y719. In total there are 1440 words, wherein Cb is a hexadecimal value representing the amount of chrominance deviation from blue, Cy is a hexadecimal value representing the amount of chrominance deviation from yellow, and Y is a hexadecimal luminance value.

The blanking section 14 includes 268 words. According to the order of the chrominance deviation from blue, luminance, and chrominance deviation from yellow of the digital image information of the active video section 16, hexadecimal values [80] (i.e., the binary value [1000 0000]), or [10] (i.e., the binary value [0001 0000]) and [80] are filled in within the blanking section 14.

As can be seen from the above explanation, currently the blanking section 14 only includes hexadecimal values [80] and [10]. For this reason, the blanking section 14 is not fully utilized. If it were possible to insert digital audio information in the blanking section 14, and if the inserted digital audio information in the blanking section 14 would not result in any decoding errors of the digital television decoding digital scanning line 1, such an enhancement would raise the efficiency of the digital scanning line 1.

### SUMMARY OF THE INVENTION

According to an exemplary embodiment of the present invention, a method of transmitting data by inserting audio information for use within a video editing apparatus is disclosed. The method includes encoding at least one analog audio signal into digital audio channel information according to an encoding format, the digital audio channel information including a length element and an audio encoded element; utilizing at least a first noise bit to replace at least one bit from within the length element to thereby generate a replacement length element; utilizing at least a second noise bit to replace at least one bit from the audio encoded element to thereby generate a replacement audio encoded element; generating replacement audio channel information according to the replacement length element and the corresponding replacement audio encoded element; according to all the replacement audio channel information generating a replacement digital audio sample; and inserting the replacement digital audio sample into a blanking section of transmitted data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows the 8-bit encoding format utilized by the CCIR656 standard according to the related art.

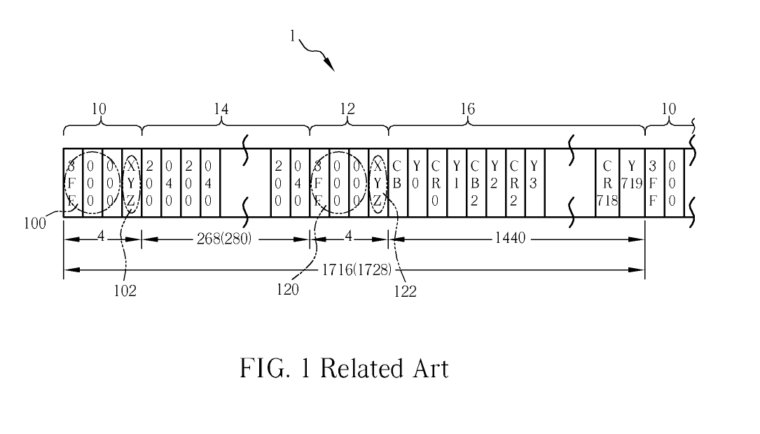

FIG. 2 shows the 10-bit encoding format utilized by the CCIR656 standard according to the related art.

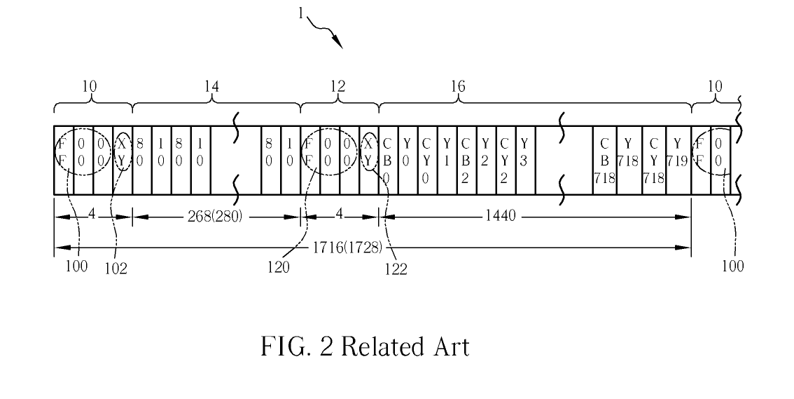

FIG. 3 shows an 8-bit encoding format for CCIR656 standard according to an exemplary embodiment of the present invention.

FIG. 4 shows method steps according to an exemplary embodiment of the present invention.

FIG. 5 shows replacement digital audio sample encoded utilizing 8-bit CCI656 standard according to an exemplary embodiment of the present invention.

### DETAILED DESCRIPTION

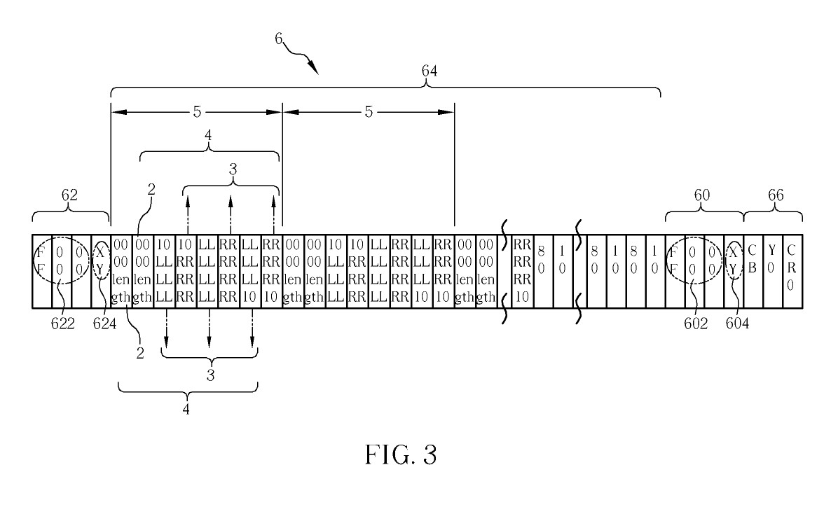

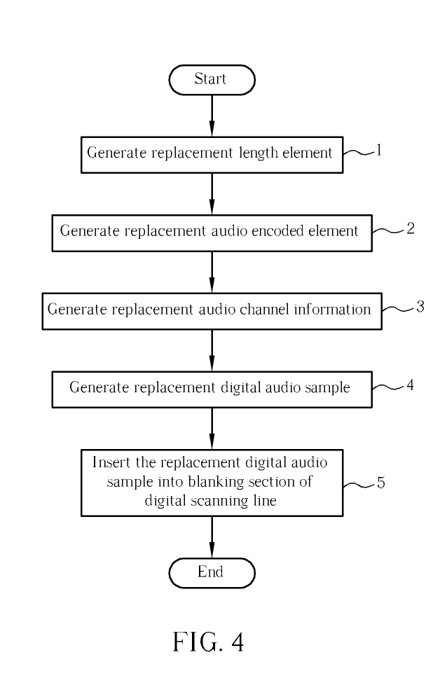

The present invention discloses a method for inserting audio information into transmitted data and is for use within an audiovisual editing apparatus. FIG. 3 shows an exemplary embodiment of the present invention. In FIG. 3, the audiovisual editing apparatus is compliant with a digital audio encoding format (20-bit, 24-bit, or 32-bit digital audio encoding format) and compiles digital audio channel data from different direction or frequency analog audio. In an embodiment of the present invention, each audio channel includes 20-bit audio information in a digital audio encoding format, which is divided into left audio channel information and right audio channel information. In the following, L and R are utilized to indicate these different channels. The digital audio channel information includes a length element and an audio encoded element, wherein the length element is a hexadecimal value formed by a plurality of words. The audio encoded element corresponding to each length element is composed of a plurality of bits. In an embodiment of the present invention, the length element is a four digit hexadecimal number utilized to indicate the length of the audio encoded element. The audio encoded element is composed from the least significant (LS) 6 bits, most significant (MS) 6 bits, and the middle 8 bits. The audio encoded element is a multiple digit hexadecimal number utilized to indicate analog audio, and after compiling the digital audio channel information, the audiovisual editing apparatus performs the following steps illustrated in FIG. 4:

Step 1: Each of the length elements has at least one bit replaced with at least one first noise bit to thereby generate a replacement length indicator 2 including the first noise bit. An embodiment of the present invention includes setting the first noise bit including the start of the replacement length indicator to 00 00. In this embodiment of the present invention, the replacement length element 2 includes a left side replacement length element and a right replacement length element.

Step 2: Each of the audio encoded elements has at least one bit replaced with at least one second noise bit to thereby generate a replacement audio encoded element 3 including the second noise bit. In an embodiment of the present invention, the second noise bit is configured so that the start and the end of the replacement audio encoded element 3 is set to 10. In this embodiment of the present invention, the replacement audio encoded element 3 includes a left replacement audio encoded element and a right replacement audio encoded element.

Step 3: Each replacement length element 2 and its corresponding replacement audio encoded element 3 form replacement audio channel information 4. In this embodiment of the present invention, there is left replacement channel information and right replacement channel information.

Step 4: Each replacement audio channel information 4 forms a replacement digital audio sample 5: the replacement digital audio sample 5 utilizes the first and second noise bits to avoid any region of the replacement digital audio sample 5, after being encoded via an encoding format to thereby form transmitted data (e.g., scanning line digital information) 6, having a starting area indication 60 or an ending area indication 62 being the same as reference elements 602, 622, respectively. In this embodiment of the present invention, it is through the setting of the first noise bit and the second noise bit that the situation of repeating 8 and 0 or repeating 8 and 1 is avoided.

Step 5: Next, take the replacement digital audio sample 5 and insert it into a blanking section 64 of the digital scanning line information 6.

In this way, the scanning line digital information 6 can simultaneously transmit digital video information and the replacement digital audio sample 5, which meets the goal of increasing the transmitting efficiency of the digital scanning line 6.

In an embodiment of the present invention, different direction or frequency analog audio signals can be encoded into digital audio information according to a 20-bit digital audio encoding format. The digital scanning line information 6 can utilize CCIR defined standard CCIR656 with 8 or 10 bits, or can be composed of other digital encoding formats. Utilizing 8-bit CCIR656 as an example, please refer to FIG. 3. The starting indication area 60 and the ending indication area 62 of the digital scanning line information 6 is defined as the hexadecimal value having the words: [FF 00 00 XY] (where each word indication has 8 bits). The reference elements 602, 622 are set as the words [FF 00 00]. That is, the reference elements 602, 622 are binary values set to [11111111 00000000 00000000]. The fourth words form information elements 604, 624 and can utilize different hexadecimal values for the digital encoding words. This can be utilized to indicate the first field and the second field of the frame, field or line blanking indicator, starting indicator 60 or ending indicator 62, and according to the field or line blanking indicator, indicate the starting region or the ending region 62 generated inspection indicator information. [XY] is utilized to indicate these different values.

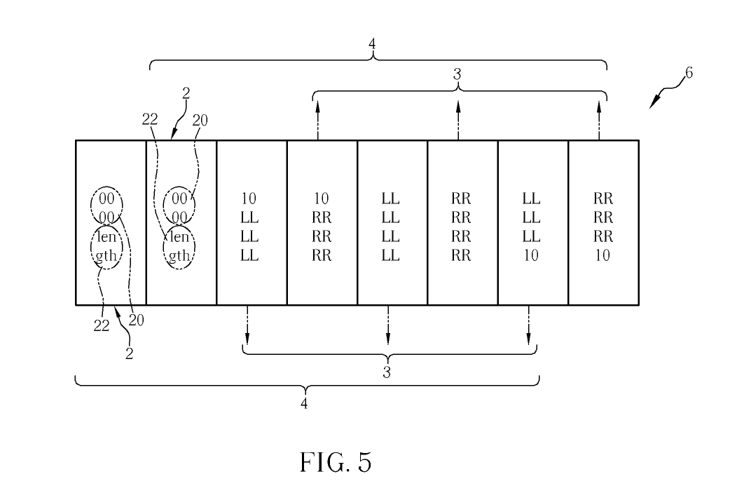

Please refer to FIG. 5. Blanking region 64 includes replacement length element 2 and replacement audio encoded element 3. The replacement audio encoded element 3 is positioned after the replacement length element 2. The replacement length indicator 2 contains in order a fixed encoding group 20 and a replacement audio length group 22. The fixed encoding group 20 is written into four of the first noise bits, and four of the first noise bits are set to digital values [0]. Each of the replacement audio length groups 22 is written into four bits and is utilized to indicate corresponding encoding length of the replacement audio encoded element 3. Each of the replacement audio length groups 22 in FIG. 3 and FIG. 4 are indicated by the words [len gth]. In this way, the replacement length element 2 is composed of four digital values [00 00 len gth], which are different than reference elements 602 and 622.

Continuing, the replacement audio encoded element 3 uses the second noise bit to respectively replace the front first and second bits and the last two bits of the audio encoded element 3. Then the two second noise bits are ordered as digital values [1] and [0]. In this way, all parts of the replacement audio encoded element 3 are completely different than the reference elements 602 and 622. Additionally, the first noise bit and the second noise bit can be set to avoid continuous 8 and 0 or continuous 8 and 1 situations. By making sure that every portion of the resulting composed replacement digital audio sample 5 of the replacement audio information 4 is not exactly the same as the reference elements 602, 622, mistaken identification is avoided.

Please again refer to FIG. 3. In the area of the blanking section 64 not filled in with the replacement digital audio sample 5, according to the order of chrominance deviation from blue, luminance, and the chrominance deviation from yellow of the active video region 66 in the digital scanning line information 6, the hexadecimal values [80] (i.e., binary values [1000 0000]), [10] (e.g., binary values [0001 0000]) and [80], can be filled in right up until the blanking section 64 is fully filled.

Using the 10-bit digital encoding format of the CCIR656 standard defined by the CCIR as an additional example, in the area of the blanking section 64 not filled in with the replacement digital audio sample 5, according to the order of chrominance deviation from blue, luminance, and the chrominance deviation from yellow of the active video region 66 in the digital scanning line information 6, the hexadecimal values [200] (i.e., binary values [01 0000 0000]), [40] (e.g., binary values [00 0100 0000]) and [200], can be filled in right up until the blanking section 64 is fully filled. Furthermore, in the 10-bit digital encoding format digital scanning line 6 of the CCIR656 standard, when it is desired to fill in digital audio information, the length element and the audio encoded element is forced to have replacements made with the first and second noise bits, this results in replacement audio information 4 being different than the reference elements 602, 622.

Please refer to FIG. 5. In this exemplary embodiment of the present invention, each of the replacement audio information 4 is interlaced with replacement length element 2 and replacement audio encoded element 3 being respectfully arranged within the blanking region 64. In other words, replacement audio information 4 is written in the blanking section 64 of the CCIR 656 standard's 8-bit digital encoding format encoding position, which is exactly adjacent with the active pixel 66's chrominance deviation from blue and the chrominance deviation from yellow encoding position. Following replacement audio information 4 written to the blanking section 64 of the CCIR656 standard's 8-bit digital encoding format encoding position is instead exactly adjacent with the active video region 66's luminance encoding position. In this way, when the digital scanning line information 6 is decoded by the digital television, each replacement audio information 4 with the same chrominance deviation from blue, chrominance deviation from yellow, and luminance, is respectfully placed in different temporarily storage areas after being decoded. Especially in the situation when each replacement audio information 4 is stored in left and right audio digital tracks, the digital television can reduce reading of each replacement audio information 4 transmission channel, and can simplify the digital television circuitry. Furthermore, such a configuration further allows the digital video information and the digital audio information to be more synchronized, and reduces influences of delay differences.

Those skilled in the art will readily observe that numerous modifications and alterations of the device and method may be made while retaining the teachings of the invention.

What is claimed is:

1. A method of transmitting data by inserting audio information for use within a video editing apparatus, the method including the following steps:
encoding at least one analog audio signal into digital audio channel information according to an encoding format, the digital audio channel information including a length element and an audio encoded element;
utilizing at least a first noise bit to replace at least one bit from within the length element to thereby generate a replacement length element;
utilizing at least a second noise bit to replace at least one bit from the audio encoded element to thereby generate a replacement audio encoded element; and
generating replacement audio channel information according to the replacement length element and the corresponding replacement audio encoded element.

2. The method of claim 1, further comprising:
generating a replacement digital audio sample according to all the replacement audio channel information; and inserting the replacement digital audio sample into a blanking section of transmitted data.

3. The method of claim 2, wherein the transmitted data comprises a digital scanning line.

4. The method of claim 2, wherein the transmitted data is compliant with a Consultative Committee of International Radio (CCIR) defined CCIR656 standard 8-bit digital encoding format.

5. The method of claim 2, wherein the replacement length element is position within the blanking section.

6. The method of claim 2, wherein the replacement audio encoded element is positioned within the blanking section.

7. The method of claim 6, wherein the replacement audio encoded element is positioned after the replacement length element.

8. The method of claim 2, wherein in the blanking section, parts unfilled with the replacement digital audio sample are filled in order with at least one particular value according to a characteristic of the transmission information, right up until the blanking section is completely filled.

9. The method of claim 2, wherein the replacement audio sample includes left replacement channel information and right replacement channel information.

10. The method of claim 1, wherein the analog audio signal is encoded into the digital audio channel information according to a 20-bit digital format audio encoding format.

11. The method of claim 1, wherein the replacement length element includes at least one fixed encoding group, and the first noise bit is set within the fixed encoding group.

12. The method of claim 1, wherein the replacement length element comprises at least one replacement audio length group utilized to indicate corresponding encoding length of the replacement audio encoded element.

13. The method of claim 1, wherein the second noise bit replaces the first and second bits and the last two bits of the audio encoded element to thereby generate the replacement audio encoded element.

14. The method of claim 1, wherein the replacement length element includes a left replacement length element and a right replacement length element.

15. The method of claim 1, wherein the replacement audio encoded element includes a left replacement audio encoded element and a right replacement audio encoded element.
